(19) United States
(12) Patent Application Publication
(10) Pub. No.: US 2025/0095508 A1
(43) Pub. Date: Mar. 20, 2025

(54) APPARATUS FOR CLASS ADMINISTRATION AND A METHOD OF USE

(71) Applicant: Anytime Movement, LLC, Nashua, NH (US)

(72) Inventors: James L Jacobs, II, Nashua, NH (US); Jonas Amberger, Eliot, ME (US)

(73) Assignee: Anytime Movement, LLC, Nashua, NH (US)

(21) Appl. No.: 18/368,947

(22) Filed: Sep. 15, 2023

(51) Int. Cl. G09B 19/00; G06T 19/00; G06V 40/20; G09B 5/06

(52) U.S. Cl. CPC G09B 19/003; A63B 24/0075; G06T 19/006; G09B 5/065; A63B 2024/0081

(57) ABSTRACT

An apparatus for class administration, the apparatus comprising a first input device, the first input device configured to receive at least audio-visual data of an instructor, at least a processor, a memory communicatively connected to the at least a processor, wherein the memory contains instructions configuring the at least a processor to receive instructor data from the first input device, generate instructions data, create a user interface data structure, wherein the user interface data structure comprises the instructor data and the instructions data and transmit the instructor data, the instructions data, and the user interface data structure, and a graphical user interface (GUI) communicatively connected to the at least a processor, the GUI configured to receive the user interface data structure, and display the instructions data and the instructor data as a function of the user interface data structure.

### FIELD OF THE INVENTION

The present invention generally relates to the field of class administration. In particular, the present invention is directed to remote fitness classroom administration.

### BACKGROUND

Virtual fitness class administration is in many cases not reactive to the performance of class participants. In addition, virtual fitness class administration in many cases does not provide helpful instructions that may aid a participant in following the class properly.

### SUMMARY OF THE DISCLOSURE

In an aspect an apparatus for class administration is illustrated. Apparatus includes a first input device, the first input device configured to receive at least audio-visual data of an instructor. Apparatus further includes at least a processor, and a memory communicatively connected to the at least a processor, wherein the memory contains instructions configuring the at least a processor to receive instructor data from the first input device, generate instructions data, create a user interface data structure, wherein the user interface data structure comprises the instructor data and the instructions data and transmit the instructor data, the instructions data, and the user interface data structure. Apparatus further includes a graphical user interface (GUI) communicatively connected to the at least a processor, the GUI configured to receive the user interface data structure and display the instructions data and the instructor data as a function of the user interface data structure.

In another aspect a method of administering a class is illustrated. The method includes receiving by at least a processor, instructor data from a first input device, wherein the first input device is configured to receive at least audio-visual data of an instructor, generating, by the at least a processor, instructions data, creating by the at least a processor, a user interface data structure, wherein the user interface data structure comprises the instructor data and the instructions data. The method further includes transmitting, by the at least a processor, the instructor data, the instructions data, and the user interface data structure to a graphical user interface (GUI) communicatively connected to the at least a processor, wherein the GUI is configured to receive the user interface data structure and display the instructions data and the instructor data as a function of the user interface data structure.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for classroom administration;

FIG. 2 is a block diagram of exemplary embodiment of a machine learning module;

FIG. 3 is a diagram of an exemplary embodiment of a neural network;

FIG. 4 is a block diagram of an exemplary embodiment of a node;

FIG. 5 is a flow diagram illustrating an exemplary embodiment of a method for classroom administration; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and methods for classroom administration. In an aspect, apparatus contains an input device configured to receive audio-visual data of an instructor, wherein the audio-visual data may be used to generate instructions for class participants.

Aspects of the present disclosure can be used to administer aerobic related activities. Aspects of this disclosure can further be used to administer aerobic activities based on participant input.

Aspects of the present disclosure allow for interactive remote learning wherein a user may interact with an instructor through the use of a computing device. Exemplary embodiments illustrating aspects of the present disclosure are described below in the context of several specific examples.

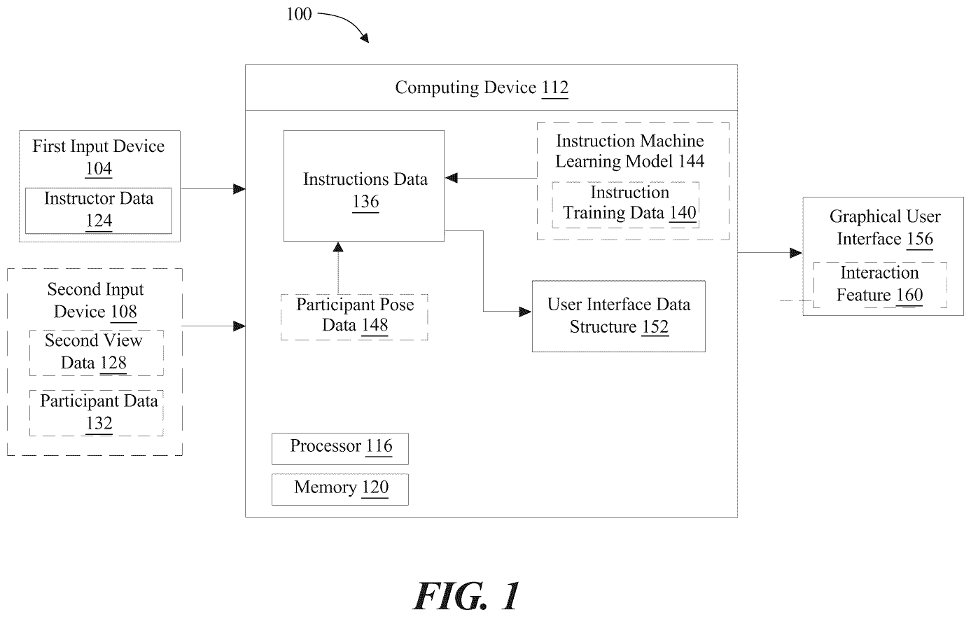

Referring now to FIG. 1, an exemplary embodiment of an apparatus 100 for class administration is illustrated. Apparatus 100 include a first input device 104. First input device 104 may be consistent with input device. “Input device” as described herein is a component capable of receiving data that may then be used for data manipulation and/or any other computer processing features. In some embodiments, input device may include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively where “image” is used as a verb, in this disclosure, it refers to generation and/or formation of an image. In some embodiments, input device may include a machine vision system that includes at least a camera. A machine vision system may use images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ϕ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure. In some embodiments, input device may include an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. In some cases, input device may include a sensor or a plurality of sensors configured to capture the surrounding environment of a classroom. For example, input device may include a temperature sensor, wherein the temperature sensor is configured to receive the temperature of a classroom. Input device may further include a hear rate sensor, wherein the heart rate sensor is configured to capture the heart rate of an instructor. Input device may further include a wearable input device, wherein the wearable input device may receive data associated with an instructor such as hear rate, body temperature, body oxygen levels and the like. Input device may include a remote device such as a wrist-based optical heart rate sensor. Input device may further include any device or component capable of receiving audio-visual data. This may include but is not limited to, a computing device 112, a smartphone, a tablet and the like.

With continued reference to FIG. 1, First input device 104 is configured to receive at least audio-visual data of an instructor. “Instructor” as described herein is an individual capable teaching a class. The class may include a yoga class, a kickboxing class, a cycling class, or any other class that involves aerobic or cardio-related activities. First input device 104 may comprise video capture device, a camera, a microphone and/or the like in order to receive audio visual data. First input device 104 may further comprise any computing device 112 as described above wherein first input device 104 may receive-audio visual data from a database or another computing device 112. In some cases, first input device 104 is configured to receive audio-visual data of an instructor during a cardio related or aerobic activity. This includes, but is not limited to, kickboxing, dancing, cycling, running, yoga, swimming, jumping rope, stair climbing, martial arts, karate, jumping jacks, splits, jumps, and other cardio related activities.

With continued reference to FIG. 1, apparatus 100 may further include a second input device 108 wherein the second input device 108 may be consistent with input device, or first input device 104 as described above. In some cases, first input device 104 includes a second input device 108. In some cases, first input device 104 and second input device 108 are one unified component, wherein the one unified component is configured to receive a plurality of data.

With continued reference to FIG. 1, first input device 104 and/or second input device 108 may include a an augmented reality (AR) device. As used in this disclosure, an “augmented reality device” is a device that permits a user to view a typical field of vision of the user and superimposes digital information and/or graphic on the field of vision. AR device may include a view window. A “view window,” for the purpose of this disclosure, is a portion of the AR device that permits a user to observe a view of a field of vision; view window may include a transparent window, such as a transparent portion of goggles such as lenses or the like. Additionally, or alternatively, view window may include a screen that displays a field of vision to a user. In some embodiments, AR device may include a projection device, defined as a device that inserts an image into a field of vision. Where view window includes a screen, projection device may include a software and/or hardware component that adds an inserted graphic into a signal to be rendered on the screen. Projection device and/or view window may make use of reflective waveguides, diffractive waveguides, or the like to transmit, project, and/or display graphics. For instance, and without limitation, projection device may project images through and/or reflect images off an eyeglass-like structure and/or lens piece, where either both field of vision and images from projection device may be so displayed, or the former may be permitted to pass through a transparent surface. Projection device and/or view window may be incorporated in a contact lens or eye tap device, which may introduce images into light entering an eye to cause display of such images. Projection device and/or view window may display some images using a virtual retina display (VRD), which may display an image directly on a retina of a user.

With continued reference to FIG. 1, in some cases, AR device may be configured to receive a view feed. As used in this disclosure, a “view feed” refers to a real-time visual data obtained from AR device as the user navigates and interacts with the physical environment. In a non-limiting example, view feed may represent user's perspective and field of view. Capturing view feed may include capturing the surrounding environment, objects, any relevant spatial information, and/or the like of the user. In an embodiment, view feed may serve as a foundation for AR device, wherein view feed may provide visual data to align, anchor, or otherwise render digital content onto the user's view of the real world. In some cases, view feed may be utilized for various image processing, computer vision, and/or machine learning tasks, such as, without limitation, object recognition, spatial mapping, user's position and/or movement tracking, and/or the like described herein.

With continued reference to FIG. 1, AR device may be implemented in any suitable way, including without limitation incorporation of or in a head mounted display, a head-up display, a display incorporated in eyeglasses, googles, headsets, helmet display systems, or the like, a display incorporated in contact lenses, an eye tap display system including without limitation a laser eye tap device, VRD, or the like. Persons skilled in the art, upon reviewing the entirety of this disclosure, will be aware of various optical projection and/or display technologies that may be incorporated in AR device consistently with this disclosure.

With continued reference to FIG. 1, view window, projection device, and/or other display devices incorporated in AR device may implement a stereoscopic display. A “stereoscopic display,” as used in this disclosure, is a display that simulates a user experience of viewing a three-dimensional (3D) space and/or object, for instance by simulating and/or replicating different perspectives of a user's two eyes; this is in contrast to a two-dimensional image, in which images presented to each eye are substantially identical, such as may occur when viewing a flat screen display. Stereoscopic display may display two flat images having different perspectives, each to only one eye, which may simulate the appearance of an object or space as seen from the perspective of that eye. Alternatively, or additionally, stereoscopic display may include a three-dimensional display such as a holographic display or the like. Persons skilled in the art, upon reviewing the entirety of this disclosure, will be aware of various alternative or additional types of stereoscopic display that may be employed in AR device.

With continued reference to FIG. 1, AR device may include a field camera. A “field camera,” as used in this disclosure, is an optical device, or combination of optical devices, configured to capture a field of vision as an electrical signal, to form a digital image. Field camera may include a single camera and/or two or more cameras used to capture a field of vision; for instance, and without limitation, the two or more cameras may capture two or more perspectives for use in stereoscopic and/or three-dimensional display, as described above. Field camera may capture a feed including a plurality of frames, such as without limitation a video feed.

With continued reference to FIG. 1, apparatus 100 includes a computing device 112. Computing device 112 and/or apparatus 100 includes a includes at least a processor 116. Processor 116 may include, without limitation, any processor 116 described in this disclosure. Processor 116 may be included in a computing device 112. Computing device 112 may include any computing device 112 as described in this disclosure, including without limitation a microcontroller, microprocessor, digital signal processor (DSP) and/or system on a chip (SoC) as described in this disclosure. Computing device 112 may include, be included in, and/or communicate with a mobile device such as a mobile telephone or smartphone. Computing device 112 may include a single computing device 112 operating independently, or may include two or more computing device 112 operating in concert, in parallel, sequentially or the like; two or more computing device 112s may be included together in a single computing device 112 or in two or more computing device 112s. Computing device 112 may interface or communicate with one or more additional devices as described below in further detail via a network interface device. Network interface device may be utilized for connecting computing device 112 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing device 112s, and any combinations thereof. A network may employ a wired and/or a wireless mode of communication. In general, any network topology may be used. Information (e.g., data, software etc.) may be communicated to and/or from a computer and/or a computing device 112. Computing device 112 may include but is not limited to, for example, a computing device 112 or cluster of computing device 112s in a first location and a second computing device 112 or cluster of computing device 112s in a second location. Computing device 112 may include one or more computing device 112s dedicated to data storage, security, distribution of traffic for load balancing, and the like. Computing device 112 may distribute one or more computing tasks as described below across a plurality of computing device 112s of computing device 112, which may operate in parallel, in series, redundantly, or in any other manner used for distribution of tasks or memory 120 between computing devices 112. Computing device 112 may be implemented, as a non-limiting example, using a “shared nothing” architecture.

With continued reference to FIG. 1, computing device 112 may be designed and/or configured to perform any method, method step, or sequence of method steps in any embodiment described in this disclosure, in any order and with any degree of repetition. For instance, computing device 112 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 112 may perform any step or sequence of steps as described in this disclosure in parallel, such as simultaneously and/or substantially simultaneously performing a step two or more times using two or more parallel threads, processor 116 cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 112 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a processor 116/module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, apparatus 100 includes a memory 120 communicatively connected to processor 116. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device 112. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 120 contains instructions configuring the at least a processor 116 to receive instructor data 124 from first input device 104. “Instructor data” as defined herein is any data relating to classroom administration of an aerobic or cardio-related activity. Instructor data 124 may include audio-visual data of an instructor leading a class, instructor data 124 may further include a heart rate of the instructor during class administration. Instructor data 124 may further include the temperature of the classroom, the aerobic activity being performed, the materials or components needed for the aerobic activity being performed, the location of the activity being performed, the time and date of the activity being performed, and the like. Instructor data 124 may further include audio-visual data of an instructor capturing a front view, a side view a back view, a top view a bottom view and the like, a perspective view (e.g., from the perspective of the instructor) and the like. Instructor data 124 may further include current class data. “Current class data” as described herein is data referring to a live class occurring at a specific location. Current class data may include data received substantially close to the time it was recorded or received. For example, current class data may include an ongoing class that is occurring in real time. Current class data may include audio-visual data that recorded and received at the same time. Instructor data 124 may further include previous class data. “Previous class data as described herein refers to data relating to a previously recorded class. For example, previous class data may include audio-visual data of a class captured on a previous data, or prior to a currently occurring class. Previous class data may include any instructor data 124 as described above. Previous class data may further include feedback data wherein feedback data comprises feedback of participants from a previous class. Previous class data may be retrieved from a database. In some cases, first input device 104 may retrieve or receive previous class data from a database. In some cases, previous class data may be retrieved from a second input device 108.

With continued reference to FIG. 1, database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, apparatus 100 may include second input device 108 as described above wherein second input device 108 is configured to receive second view data 128. “Second view data” as described herein is data relating to an alternate view of an instructor. For example, if instructor data 124 received from first input device 104 includes a front view of an instructor, second view data 128 may include a side view of instructor. In some cases, first input device 104 includes second input device 108. In some cases, first input device 104 includes a plurality of input devices wherein one of the plurality of input devices includes second input device 108. In some cases, second view data 128 may be consistent with first view data wherein second view data 128 may capture data from another location or point in a classroom. In some cases, second input device 108 may be configured to receive participant data 132. “Participant data 132” as described herein is any data relating to a classroom participant. Participant data 132 may include feedback data wherein feedback data is the comments or reaction of a participant currently in the class. Participant data 132 may further include any audio-visual data of a classroom participant. Participant data 132 may further include any data relating to a participant present in a classroom or remote class. For example, participant data 132 may include heart rate data, oxygen level data, the temperature of participant and the like. Participant data 132 may be used to notify or give notice to an instructor of participants in the classroom. In some cases, second input device 108 is situated in another location such as the house of a participant. In some cases, second input device 108 may be saturated in a similar location as first input device 104, such as for example, in a classroom. Participant data 132 may further include the experience and background of a participant. This may include the participant's preferences, previous class history, current expertise level (e.g., ranging from 1-10 or ranging from low, medium, high and the like), current cardio capabilities, weight, height, maximum running speed, maximum weight that can be lifted, maximum exercise time and the like. Participant data 132 may be used to notify an instructor what type of class to give participants and the intensity of the class.

With continued reference to FIG. 1, memory 120 further contains instructions configuring processor 116 to generate instructions data 136. “Instructions data” as described here is data relating to a specific activity recorded by first input device 104. For example, instructions data 136 may include data relating to kickboxing class. Instructions data 136 may include instructions on how to perform a specific activity. For example, instructions data 136 may include instructions on how high to raise a participant's leg when kickboxing. Instructions data 136 may further include data relating any components necessary for proper participation of a class. For example, instructions data 136 may include the type, size, height, or color of a yoga mat necessary for a yoga class. Instructions data 136 may further include suggested instructions data 136 wherein suggested instructions data 136 is optional directions for participating in a class. for example, suggested instructions data 136 may include a suggested speed on a treadmill, or a suggested incline. Suggested instructions data 136 may further include a suggested temperature of the room or a suggested difficulty on an elliptical. Instructions data 136 may further include instructions pose data wherein instructions pose data is instructions on how to achieve a specific pose necessary for the particular activity. Instructions data 136 may further include instructions telling a participant to speed up, slow down, or take a break. Instructions data 136 may further advice data, wherein advice data may advise a client how successful they are in participating in a class. instructions data 136 may further include a plurality of data wherein the plurality of data corresponds to a plurality of steps. Instructions data 136 may further include the type of class being instructed, the time necessary for the class and the like. Instructions data 136 may further include data relating to the difficult level of the class Instructions data 136 may further include a plurality of steps wherein each step contains data relating to the amount of time the step should take. In some cases, instructions data 136 may be used to signify to participants the class that is being instructed and the instructions necessary for that class. Additionally, or alternatively instructions data 136 may be used to notify an instructor of the type of class that is being instructed and the difficulty. Instructions data 136 may be received from an input device, similar to an input device as described in this disclosure. Instructions data 136 may further be retrieved from a database.

With continued reference to FIG. 1, generating instructions data 136 may include receiving instructions data 136 using a lookup table. A “lookup table” as described herein is an array of predetermined values wherein each value may be looked up using a key corresponding to that specific value. For example, a user may use an input device to lookup a value associated with kickboxing wherein the value associated with kickboxing contains instructions data 136 related to kickboxing. Instructions data 136 may include a plurality of precomputed or predetermined data wherein the plurality of predetermined data is looked up and retrieved for a specific classroom instruction.

With continued reference to FIG. 1, generating the instructions data 136 may further includes generating the instructions data 136 as a function of instructor data 124. Instructions data 136 may be generated as a function of instructor data 124 by using a data classifier. The data classifier disclosed herein may be consistent with the classifier described below. In some embodiments, a data classifier may be trained with training data correlating instructions data 136 to instructions data 136. As a non-limiting example, data classifier may correlate a specific heart rate, temperature, and the like present in instructor data 124 to a specific activity. In some embodiments training data may be received from a user, a third party (e.g. someone not part of the classroom instruction), an instructor, pattern database, external computing device 112, previous iterations of the processing and the like. In some embodiments, outputs of a data classifier may be used to train the data classifier. In some embodiments, training data may be stored in a database. In some embodiments, training data may be retrieved from a database.

With continued reference to FIG. 1, instructor data 124 may be classified to instructions data 136 group using a group lookup table. A lookup table may be used to replace a runtime computation with an array indexing operation. In some embodiments, at least a processor 116 may ‘lookup’ a given instructor data 124 to one or more instructions groups. As a non-limiting example, at least a processor 116 may ‘lookup’ a given input by an instructor, such as kickboxing to a kickboxing group.

With continued reference to FIG. 1, generating instructions data 136 as a function of instructor data 124 may include using Image Recognition. “Image Recognition” also known as machine vision is a process in which a computing device 112 recognizes or interprets components within audiovisual data. For example, image recognition may include a computing device 112 detecting or recognizing a chair in an image or a video of a chair. Image recognition may include receiving at least one image from instructor data 124. The at least one image is then converted into an array of numerical values wherein each numerical value may represent a specific intensity within the at least one image. Image recognition may receive training data, wherein the training data correlates a plurality of the numerical values to a plurality of image recognition objects. In some embodiments, training data may be received from a user, a third party, database, external computing device 112s, previous iterations of processing, and/or the like as described in this disclosure. Training data may further be comprised of previous iterations. Training data may be stored in database and retrieved from database. Determining a specific object may within the plurality of image recognition objected may include training a machine learning model as a function of the training data and generating a specific object as a function of the machine learning model. The data relating to the specific object may then be used to determine what activity is taking place wherein computing device 112 may retrieve the appropriate instructions data 136. For example, image recognition may be used to recognize an elliptical wherein computing device 112 may retrieve instructions containing instructions for an elliptical class.

Still referring to FIG. 1, a “classifier” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Computing device 112 and/or another device may generate a classifier using a classification algorithm, defined as a process whereby a computing device 112 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Further referring to FIG. 1, processor 116 and/or computing device 112 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 112 may then calculate a likelihood table by calculating probabilities of different data entries and classification labels. Computing device 112 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, processor 116 and/or computing device 112 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Continuing to reference FIG. 1, processor 116 may use a machine learning module, such as a machine learning module as described herein, to implement one or more algorithms or generate one or more machine-learning models, such as instructions machine learning model, to calculate at least one instructions data 136. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from a database, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. A machine learning module, such as instructions module, may be used to generate instructions machine learning model and/or any other machine learning model using training data. Instructions machine learning model may be trained by correlated inputs and outputs of training data. Training data may be data sets that have already been converted from raw data whether manually, by machine, or any other method. Instructions training data may be stored in a database. Instructions training data may also be retrieved from database.

With continued reference to FIG. 1, generating the instructions data 136 as a function of the instructor data 124 may further include generating instructions data 136 using a machine learning model. Generating the instructions data 136 as a function of the instructor data 124 may include receiving instruction training data 140. In an embodiment, instruction training data 140 may include a plurality of instructor data 124 that is correlated to a plurality of instructions data 136. For example, instruction training data 140 may be used to show instructor data 124 that is correlated to one the plurality of instructions data 136. In an embodiment instructions data 136 may be used to instruct a participant on the moves, positions or materials used by the instructor. In some embodiments, instructions training data may be received from a user, third party, database, external computing device 112s, previous iterations of processing, and/or the like as described in this disclosure. Instruction training data 140 may further be comprised of previous iterations of instructor data 124 and instructions data 136. Instructions training data may be stored in a database and/or retrieved from a database. Generating instructions data 136 may further include training an instruction machine learning model 144 as a function of instruction training data 140 and generating instructions data 136 as a function of the instruction machine learning model 144. In some cases, instruction training data 140 may be trained through participant input wherein a participant may determine if the instructions data 136 is accurate and/or applicable to the current class instructions.

With continued reference to FIG. 1, generating instructions data 136 as a function of the instructor data 124 includes determining instructor pose data as a function of the instructor data 124. “Instructor pose data” as described herein relates to the posture and/or positioning of an instructor during class administrations. For example, instructor pose data may indicate that an instructor is walking, sitting, lying down, standing straight, standing with one leg up, standing with their arms out, in a swimming pose, jumping in one position and the like. In some cases, instructor pose data may be used to indicate what specific activity an instructor is partaking in based on their pose. For example, an instructor walking may indicate that the instructor is on a treadmill. Similarly, data relating to a swimming pose may indicate that an instructor is swimming. Swimming pose data may further be used to generate instructions data 136 wherein instructions data 136 may detail how to achieve a specific pose achieved by an instructor. For example, instructor pose data may include data relating to a standing pose in yoga wherein generating instructions data 136 includes generating instructions data 136 relating to instructions of a standing pose. Instructor pose data may be determined by user input. Instructor pose data may further be determined by retrieving instructor pose data form a database. Instructor pose data may further be determined using image classifiers. An “image classifier,” as used in this disclosure is a machine-learning model, such as a mathematical model, neural net, or program generated by a machine-learning algorithm known as a “classification algorithm,” as described in further detail below, that sorts inputs of image information into categories or bins of data, outputting the categories or bins of data and/or labels associated therewith. Image classifier may be configured to output at least a datum that labels or otherwise identifies a set of images that are clustered together, found to be close under a distance metric as described below, or the like. computing device 112 and/or another device may generate image classifier using a classification algorithm, defined as a process whereby computing device 112 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In some cases, generating instructions data 136 further includes generating instructions data 136 as a function of instructor pose data. Generating instructions data 136 as a function of instructor pose data may include using a lookup table wherein the lookup table comprises a plurality of instructions wherein each of the plurality of instructions is correlated to a specific pose. In some cases, processor 116 may use an image classifier to identify a key image in plurality instructor data 124. As used herein, a “key image” is an element of visual data used to identify and/or match elements to each other. An image classifier may be trained with binarized visual data that has already been classified to determine key images in instructor data 124. An image classifier may be consistent with any classifier as discussed herein. An image classifier may receive an input of instructor data 124 and output a key image of instructor data 124. An identified key image may be used to locate a data entry relating to the image data in instructor data 124, such as an image depicting a specific aerobic activity. In an embodiment, image classifier may be used to compare visual data in instructor data 124 with visual data in another data set, such as previously inserted instructor data 124. In the instance of a video, processor 116 may be used to identify a similarity between videos by comparing them. Processor 116 may be configured to identify a series of frames of video. The series of frames may include a group of pictures having some degree of internal similarity, such as a group of pictures having similar aerobic components depicted within them or similar color profiles. In some embodiments, comparing series of frames may include video compression by inter-frame coding. The “inter” part of the term refers to the use of inter frame prediction. This kind of prediction tries to take advantage from temporal redundancy between neighboring frames enabling higher compression rates. Video data compression is the process of encoding information using fewer bits than the original representation. Any compression may be either lossy or lossless. Lossless compression reduces bits by identifying and eliminating statistical redundancy. No information is lost in lossless compression. Lossy compression reduces bits by removing unnecessary or less important information. Typically, a device that performs data compression is referred to as an encoder, and one that performs the reversal of the process (decompression) as a decoder. Data compression may be subject to a space-time complexity trade-off. For instance, a compression scheme for video may require expensive hardware for the video to be decompressed fast enough to be viewed as it is being decompressed, and the option to decompress the video in full before watching it may be inconvenient or require additional storage. Video data may be represented as a series of still image frames. Such data usually contains abundant amounts of spatial and temporal redundancy. Video compression algorithms attempt to reduce redundancy and store information more compactly.

Still referring to FIG. 1, computing device 112 may be configured to analyze any data described herein such as for example, instructor data 124, using an action module. For example, a computing device 112 may be communicatively connected to a video capture device, and a computing device 112 may include at least a processor 116 and a memory 120 communicatively connected to the at least processor 116, the memory 120 containing instructions configuring the at least processor 116 to analyze instructor data 124 using an action module.

Still referring to FIG. 1, as used herein, an “action module” is a is a software and/or hardware module configured to process or edit instructor data 124. Action module may be implemented, without limitation, using combinational or sequential hardware logic, firmware, assembly code, and/or higher-level software instructions. For instance, and without limitation, action module may include video and/or audio codec hardware and/or software, at least a graphical processing unit (GPU), and/or one or more filters and/or other signal processing software and/or hardware. It is noted that while the term “module” is used herein, this term is not intended to require any particular configuration of the corresponding software and/or hardware code and/or configuration. For example, “module” should not be construed to mean that the software code is embodied in a discrete set of code and/or circuitry independent of code and/or circuitry used to implement other elements disclosed herein. Rather, the term “module” is used herein merely as a convenient way to refer to the underlying functionality.

Still referring to FIG. 1, processor 116 may apply data compression techniques to instructor data 124, or any other data described herein. “Data compression,” as used in this disclosure, is the process of encoding information using fewer bits than the original representation. Any particular compression is either lossy or lossless. Lossless compression reduces bits by identifying and eliminating statistical redundancy. No information is lost in lossless compression. Lossy compression reduces bits by removing unnecessary or less important information. In some embodiments, processor 116 may utilize an encoder to perform data compression on instructor data 124. instructor data 124 may be compressed in order to optimize speed and/or cost of transmission of instructor data 124. For instructor data 124 including video, a processor 116 may be configured to identify a series of frames of a video. The series of frames may include a group of pictures having some degree of internal similarity, such as a group of pictures representing a scene. In some embodiments, comparing series of frames may include video compression by inter-frame coding. The “inter” part of the term refers to the use of inter frame prediction. This kind of prediction tries to take advantage from temporal redundancy between neighboring frames enabling higher compression rates. Video data compression is the process of encoding information using fewer bits than the original representation. Data compression may be subject to a space-time complexity trade-off. For instance, a compression scheme for video may require expensive hardware for the video to be decompressed fast enough to be viewed as it is being decompressed, and the option to decompress the video in full before watching it may be inconvenient or require additional storage. Video data may be represented as a series of still image frames. Such data usually contains abundant amounts of spatial and temporal redundancy. Video compression algorithms attempt to reduce redundancy and store information more compactly.

Still referring to FIG. 1, inter-frame coding may function by comparing each frame in the video with another frame, which may include a previous frame. Individual frames of a video sequence may be compared between frames, and a video compression codec may send only the differences from a reference frame for frames other than the reference frame. If a frame contains areas where nothing has moved, a system may issue a short command that copies that part of a reference frame into the instant frame. If sections of a frame move in a manner describable through vector mathematics and/or affine transformations, or differences in color, brightness, tone, or the like, an encoder may emit a command that directs a decoder to shift, rotate, lighten, or darken a relevant portion. An encoder may also transmit a residual signal which describes remaining more subtle differences from reference frame, for instance by subtracting a predicted frame generated through vector motion commands from the reference frame pixel by pixel. Using entropy coding, these residual signals may have a more compact representation than a full signal. In areas of video with more motion, compression may encode more data to keep up with a larger number of pixels that are changing. As used in this disclosure, reference frames are frames of a compressed video (a complete picture) that are used to define future frames. As such, they are only used in inter-frame compression techniques. Some modern video encoding standards, such as H.264/AVC, allow the use of multiple reference frames. This may allow a video encoder to choose among more than one previously decoded frame on which to base each macroblock in another frame.

Still referring to FIG. 1, two frame types used in inter-fame coding may include P-frames and B-frames. A P-frame (Predicted picture) may hold only changes in an image from a reference frame. For example, in a scene where a car moves across a stationary background, only the car's movements may need to be encoded; an encoder does not need to store the unchanging background pixels in the P-frame, thus saving space. A B-frame (Bidirectional predicted picture) may save even more space by using differences between a current frame and both preceding and following frames to specify its content. An inter coded frame may be divided into blocks known as macroblocks. A macroblock may include a processing unit in image and video compression formats based on linear block transforms, such as without limitation a discrete cosine transform (DCT). A macroblock may consist of 16×16 samples, for instance as measured in pixels, and may be further subdivided into transform blocks, and may be further subdivided into prediction blocks. Formats which are based on macroblocks may include JPEG, where they are called MCU blocks, H.261, MPEG-1 Part 2, H.262/MPEG-2 Part 2, H.263, MPEG-4 Part 2, and H.264/MPEG-4 AVC. After an inter coded frame is divided into macroblocks, instead of and/or in addition to directly encoding raw pixel values for each block, an encoder may identify a block similar to the one it is encoding on another frame, referred to as a reference frame. This process may be performed by a block matching algorithm. If an encoder succeeds in its search for a reference frame, a block may be encoded by a vector, known as motion vector, which points to a position of a matching block at the reference frame. A process of motion vector determination may be referred to as motion estimation. Residual values, based on differences between estimated blocks and blocks they are meant to estimate, may be referred to as a prediction error and may be transformed and sent to a decoder.

Still referring to FIG. 1, using a motion vector pointing to a matched block and/or a prediction error, a decoder may reconstruct raw pixels of an encoded block without requiring transmission of the full set of pixels. For example, a video may be compressed using a P-frame algorithm and broken down into macroblocks. Individual still images taken from a video may then be compared against a reference frame taken from another a video or augmented video. A P-frame from a video may only hold the changes in image from target a video. For example, if both a video include a similar, then what may be encoded and stored may include subtle changes such as an additional character dialogue or character appearances compared to the video without the dialogue. Exemplary video compression codecs may include without limitation H.26x codecs, MPEG formats, VVC, SVT-AV1, and the like. In some cases, compression may be lossy, in which some information may be lost during compression. Alternatively, or additionally, in some cases, compression may be substantially lossless, where substantially no information is lost during compression. In some cases, image component may include a plurality of temporally sequential frames. In some cases, each frame may be encoded (e.g., bitmap or vector-based encoding). In some embodiments, a classifier may receive an input from a processor 116 including a video encoder. In a non-limiting example, a processor 116 may select a reference frame to be encoded and may transmit the reference frame to a classifier; such a classifier may include a classifier configured to categorize images based on a pose being performed in an image, as described below. In some embodiments, categorizing reference frames using a classifier may allow for a video frame, or a section of a video represented by a frame, to be categorized. Each frame may be configured to be displayed by way of a display. Exemplary displays include without limitation light emitting diode (LED) displays, cathode ray tube (CRT) displays, liquid crystal displays (LCDs), organic LEDs (OLDs), quantum dot displays, projectors (e.g., scanned light projectors), and the like.

Still referring to FIG. 1, in some embodiments, processor 116 may perform a plurality of digital processing techniques such as acquisition, image enhancement, image restoration, color image processing, data augmentation, wavelets and multi-resolution processing, image compression, morphological processing, representation and description, object and recognition, and the like. In some embodiments, processing instructor data 124 includes utilizing feature extraction. Feature extraction is a part of computer vision, in which, an initial set of the raw data is divided and reduced to more manageable groups. “Features,” as used in this disclosure, are parts or patterns of an object in an image that help to identify it. For example a square has 4 corners and 4 edges, they can be called features of the square. Features may include properties like corners, edges, regions of interest points, ridges, etc. In some embodiments, processing instructor data 124 may include segmenting an image of the instructor data 124 utilizing image segmentation. “Image segmentation,” as used in this disclosure, is a sub-domain of computer vision and digital image processing, as described further below, which aims at grouping similar regions or segments of an image under their respective class labels.

Still referring to FIG. 1, a processor 116 may use interpolation and/or upsampling methods to process instructor data 124. For instance, processor 116 may convert a low pixel count image into a desired number of pixels. As a non-limiting example, a low pixel count image may have 100 pixels, however a desired number of pixels may be 128. Processor 116 may interpolate the low pixel count image to convert the 100 pixels into 128 pixels. It should also be noted that one of ordinary skill in the art, upon reading this disclosure, would know the various methods to interpolate a low pixel count image to a desired number of pixels. In some instances, a set of interpolation rules may be trained by sets of highly detailed images and images that may have been downsampled to smaller numbers of pixels, and a neural network or other machine learning model that is trained using the training sets of highly detailed images to predict interpolated pixel values in a facial picture context. As a non-limiting example, a sample picture with sample-expanded pixels (e.g., pixels added between the original pixels) may be input to a neural network or machine-learning model and output a pseudo replica sample-picture with dummy values assigned to pixels between the original pixels based on a set of interpolation rules. In some instances, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. I.e., you run the picture with sample-expanded pixels (the ones added between the original pixels, with dummy values) through this neural network or model and it fills in values to replace the dummy values based on the rules.

Still referring to FIG. 1, processor 116 may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. In some embodiments, processor 116 may use luma or chroma averaging to fill in pixels in between original image pixels. Processor 116 may down-sample instructor data 124 to a desired lower number of pixels. As a non-limiting example, a high pixel count image may have 256 pixels, however a desired number of pixels may be 128. Processor 116 may down-sample the high pixel count image to convert the 256 pixels into 128 pixels.

Still referring to FIG. 1, in some embodiments, processor 116 may be configured to perform downsampling on data such as without limitation instructor data 124. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 1, processor 116 may classify instructor data 124 to a plurality of categories, such as poses or movements, using a machine-learning model such as a classifier. A classifier may include a machine-learning model, such as a mathematical model, neural net, or program generated by a machine learning algorithm known as a “classification algorithm,” that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. For example, a classifier may receive a plurality of instructor data 124 and output a datum that can be used to categorize the instructor data 124 into bins, such as categories, such as poses or movements. Processor 116 may generate a classifier using a classification algorithm, which may include a process whereby a processor 116 derives a classifier from training data. Training data may include images of individuals performing poses, tagged with the poses they are performing. In some embodiments, a classifier may be applied to frames from a video, in order to categorize that frame and/or a section of the video represented by that frame. In some embodiments, a classifier may receive an input from a processor 116 including a video encoder, as described above. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, classification may include particular image requirements. In some instances, image requirements may include resolution, pixel count, and the like. Classification may include, without limitation, matching instructor data 124 to one or more requirements. Image classifier may be trained, without limitation, using training data containing images of a type to be matched, such as images of, thus image classifier may be trained to detect whether an object class depicted in a given image matches an object class depicted in a stored image, or otherwise match a subject of an image to a subject of another image.

Still referring to FIG. 1, in some embodiments, image pixel count may be modified based on the input requirements of a machine learning model, such as an image classifier. For example, an image classifier may have a number of inputs into which pixels are input, and thus may require either increasing or decreasing the number of pixels in an image to be input and/or used for training image classifier. In some embodiments, interpolation, upsampling, sample expander, low pass filter, and/or downsampling may be used to modify pixel count to a required number of pixels for an image classifier.

Still referring to FIG. 1, an action module may utilize a computer vision model, such as a computer vision model configured to detect specific poses via image processing, image recognition, motion capture, and the like. A computer vision model may be configured to translate visual data within instructor data 124 based on features and contextual information. Features and contextual information may be identified manually by a professional such as an instructor during model training.

Still referring to FIG. 1, in some embodiments, an action module may include a machine vision system. A machine vision system may use images from a camera, such as a camera included in a video capture device, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ϕ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Still referring to FIG. 1, a machine vision system may utilize a machine vision camera, or data from a machine vision camera. A video capture device may include a machine vision camera. An exemplary machine vision camera that may be included in an apparatus is an OpenMV Cam H7 from OpenMV, LLC of Atlanta, Georgia, U.S.A. OpenMV Cam includes a small, low power, microcontroller which allows execution of machine vision applications. OpenMV Cam comprises an ARM Cortex M7 processor 116 and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detection motion, for example by way of frame differencing algorithms; marker detection, for example blob detection; object detection, for example face detection; eye tracking; person detection, for example by way of a trained machine learning model; camera motion detection, for example by way of optical flow detection; code (barcode) detection and decoding; image capture; and video recording.

Still referring to FIG. 1, a camera may be a stereo-camera. As used in this disclosure, a “stereo-camera” is a camera that senses two or more images from two or more vantages. As used in this disclosure, a “vantage” is a location of a camera relative a scene, space and/or object which the camera is configured to sense. In some cases, a stereo-camera may determine depth of an object in a scene as a function of parallax. As used in this disclosure, “parallax” is a difference in perceived location of a corresponding object in two or more images. An exemplary stereo-camera is TaraXL from e-con Systems, Inc of San Jose, California. TaraXL is a USB 3.0 stereo-camera which is optimized for NVIDIA® Jetson AGX Xavier™/Jetson™ TX2 and NVIDIA GPU Cards. TaraXL's accelerated Software Development Kit (TaraXL SDK) is capable of doing high quality 3D depth mapping of WVGA at a rate of up to 60 frames per second. TaraXL is based on MT9V024 stereo sensor from ON Semiconductor. Additionally, TaraXL includes a global shutter, houses 6 inertial measurement units (IMIUs), and allows mounting of optics by way of an S-mount lens holder. TaraXL may operate at depth ranges of about 50 cm to about 300 cm.

Still referring to FIG. 1, in some cases, user/instructor/third-party avatar may be registered, by processor 116, to a view feed using computer vision model or machine vision system described herein. For the purposes of this disclosure, an “user avatar” is a virtual avatar of a user. In another embodiment, the AR device may display a third-party avatar to the user. For the purposes of this disclosure, an “third-party avatar” is a virtual avatar of a third party. For the purposes of this disclosure, “third party” is a person taking a fitness class other than a user that is taking the fitness class. In another embodiment, the AR device may display an instructor avatar to the user. For the purposes of this disclosure, an “instructor avatar” is a virtual avatar of an instructor. A “virtual avatar” as used in this disclosure is any digital creation displayed through a screen. Digital creations may include, but are not limited to, digital entities, virtual objects, and the like. The virtual avatar may be a visual representation of a user, an instructor, and/or a third party. The virtual avatar may include, without limitation, two-dimensional representations of animals and/or human characters, three-dimensional representations of animals and/or human characters, and the like. For instance and without limitation, the virtual avatar may include penguins, wolves, tigers, frogs, young human characters, old human characters, middle-aged human characters, and the like. In some embodiments, the virtual avatar may include clothing, apparel, and/or other items. Clothing may include, but is not limited to, jackets, pants, shirts, shorts, suits, ties, and the like. Apparel may include, but is not limited to, skis, ski goggles, baseball mitts, tennis rackets, suitcases, and the like. The virtual avatar may be generated as a function of user image data and/or instructor image data. For instance, and without limitation, processor 116 may generate a user avatar that corresponds to a user. For instance and without limitation, the processor 116 may generate a third-party avatar that corresponds to a third party. For instance, and without limitation, the processor 116 may generate an instructor avatar that corresponds to an instructor.

Still referring to FIG. 1, as used herein, “registration” of an avatar or any other visual elements to a view feed means identifying a location within the view feed of each pixel of each visual element or virtual avatar. Registration may be done with respect to a field coordinate system. As used herein, a “field coordinate system,” is a coordinate system of a view feed, such as a Cartesian coordinate system a polar coordinate system, or the like. Registration of a frame to a view feed may be characterized as a map associating each pixel of a frame, and/or coordinates thereof in a frame coordinate system, to a pixel of field coordinate system. Such mapping may result in a two-dimensional projection of corresponding three-dimensional coordinates on one or more two-dimensional images. For example, registration of a 2D visual element may be done by identifying a region of a field coordinate system that matches the dimensions of the visual element and displaying the visual element in that region (such as when a visual element is intended to be displayed relative to a user's field of view regardless of user movement). As another example, registration of a 3D element may be done by rendering the 3D element as voxels, taking a projection of the voxels on the field coordinate system, and displaying the projection (such as when display of a 3D visual element is desired). As another example, registration of an avatar or a visual element may be done by rendering the avatar or the visual element in a location relative to an object, taking a projection of the avatar on a field coordinate system, and displaying the projection (such as when rendering text describing instructions to an example yoga pose beside the virtual avatar iteratively performing the example yoga pose is desired). In some embodiments, registration of an avatar or a visual element may change from frame to frame. For example, if display of a rotating 3D visual element is desired, then a projection of the avatar or the visual element may differ from frame to frame, such as due to a change in the perspective of a user relative to the rotating element. As another example, display of an avatar or a visual element may change if the avatar or the visual element is displayed relative to an object, and a user/user avatar moves relative to the object.

Still referring to FIG. 1, an action module may include one or more machine-learning models such as, without limitation, an artificial neural network (ANN), a convolution neural network (CNN), and the like. For example, and without limitation, an action module may receive instructor data 124 containing a video as input. A computing device 112 may train one or more models using pose training data containing a plurality of pose vectors (i.e., an array of user joint locations in the frame image) as input corresponding to a plurality of poses as output. A computing device 112 may then apply the trained model to instructor data 124 as a pose regressor. One or more models may output a pose identifier with maximum possibility as a function of instructor data 124. A machine learning model may include a classifier. A machine learning model may be trained using a dataset of historical instructor data 124, tagged data categories; such a language model may accept instructor data 124 as an input, and categorize it as an output. For example, a language model may include a classifier trained using historical instructor data 124 tagged with the pose an instructor takes; such a classifier may accept instructor data 124 as an input and may, as an output, categorize the instructor data 124 according to the pose an instructor takes. A machine learning model may be trained to recognize poses or movements using historical image or video data, tagged with the pose or movement the subject of the photo or video is performing; such a machine learning model may accept as an input image or video instructor data 124 (for example, video or image instructor data 124 captured using a video capture device), and may categorize the image or video instructor data 124 as an output. In this way, a machine learning model may detect whether certain events (such as an instruction to perform a pose) are taking place in a class based on image or video instructor data 124.

Still referring to FIG. 1, an action module may include a language model configured to detect keywords, phrases, sentences, and the like. As used herein, a “language model” is a program capable of interpreting or producing natural language. A language model may include a machine learning model configured to recognize or interpret audio speech. A language model may include a neural network. A language model may be trained using a dataset that includes natural language. A language model may be trained using a dataset that includes historical instructor data 124. A language model may include a classifier. A language model may be trained using a dataset of historical audio elements of instructor data 124, tagged with categories of speech; such a language model may accept an audio element of instructor data 124 as an input, and categorize it as an output. For example, a language model may include a classifier trained using historical audio instructor data 124 tagged with whether an instructor's description of a pose is too complex; such a classifier may accept audio instructor data 124 as an input and may, as an output, categorize the audio instructor data 124 according to whether it is too complex. As another example, a language model may be trained using a dataset including spoken words and/or phrases, tagged with associated events (such as an instruction to perform a pose, or an instruction to take a break); such a language model may accept audio instructor data 124 as an input and may categorize the audio instructor data 124 according to whether it includes keywords or phrases associated with certain events as an output. In this way, a language model may detect whether certain events (such as an instruction to perform a pose) are taking place in a class using audio instructor data 124.

With continued reference to FIG. 1, generating instructions data 136 may include generating instructions data 136 as a function of a participant input. A “participant input” as used in this disclosure is information received from an individual participant input may include, for instance and without limitation, information entered via text fields, information entered via clicking on icons of a graphical user interface 156 (GUI 156), information entered via touch input received through one or more touch screens, and the like. A participant may input commands and or comments wherein the commands and/or comments may generate instructions data 136 or change already generated instructions data 136. As described in this disclosure a “command” is an instruction given to a computing system or a computing device 112 to perform a specific task. For example, a participant may enter a command into computing device 112 wherein computing device 112 generates a specific output as a function of the command. Command may be sent by a remote device to computing device 112. In some cases, the remote device may be communicative by at least a network, for example any network described in this disclosure including wireless (Wi-Fi), controller area network (CAN), the Internet, and the like. In some cases, participant input includes participant data 132 wherein participant data 132 is received by a participant input. In some cases, participant input is received by second input device 108. Participant input may be beneficial in situations in which participants seek to make comments about slowing down or speeding up the class. ser input may further be used to suggest alternate instructions on a specific activity. Participant input may further be used to notify an instructor to create a new activity. Participant input may further be used to repeat instructions data 136.

With continued reference to FIG. 1, generating instructions data 136 may include generating instructions data 136 as a function of instructor data 124 and participant data 132. generating instructions data 136 as a function of instructor data 124 and participant data 132 may include generating instructions data 136 as a function of instructor data 124 as described above. Generating instructions data 136 as a function of instructor data 124 and participant data 132 may further include modifying instructions data 136 as a function of participant data 132. Instructions data 136 may be modified such that instructions data 136 may be more geared towards class participants. For example, if participant data 132 indicates that one or a plurality of participants are not properly engaging in the aerobic activities, such as not being to conduct a specific pose, then instructions data 136 may be modified to in order to accommodate the participants. Modifying instructions data 136 may include modifying instructions data 136 using a machine learning model. Modifying instructions data 136 may include receiving modified training data wherein modified training data correlates a plurality of participant data 132 to a plurality of modified instructions data 136. For example, modified training data may be used to show modified instructions data 136 that is correlated to one of the plurality of participant data 132. In embodiment, modified instructions data 136 may include a more simplified version of instructions data 136. modified instructions data 136 may decrease the intensity of an aerobic workout, decrease the speed, decrease the difficulty, and may even change the workout. In some cases, modified instructions data 136 may increase the intensity of a workout, increase the difficulty and the like. In some cases, modified instructions data 136 may include more detailed instructions, such as for example, more detailed instructions for a beginner class. In contrast, modified instructions data 136 may include less detailed instructions for participants who are more advanced. In some embodiments, modified training data may be received from a user, third party, database, external computing device 112s, previous iterations of processing, and/or the like as described in this disclosure. modified training data may further be comprised of previous iterations of instructor data 124 and participant data 132. Modified training data may be stored in a database and/or retrieved from a database. Generating instructions data 136 may further include training a modified machine learning model as a function of modified training data and generating modified instructions data 136 as a function of the instruction machine learning model 144, wherein instructions data 136 receives modified instructions data 136. In some cases, modified training data may be trained through participant input wherein a participant may determine if the instructions data 136 is accurate and/or applicable to the current class instructions.

In some cases, generating instructions data 136 may include generating instructions data 136 as a function of participant data 132. Generating instructions data 136 as a function of participant data 132 may include receiving a plurality expertise levels in a plurality of participant data 132, averaging the plurality of expertise levels, and generating an average expertise level as a function of the plurality of expertise levels. The average expertise level may then be used by computing device 112 to determine an appropriate expertise level for the aerobic activity. For example, an average expertise level of the class may indicate that the average level of the class is advanced in a particular aerobic activity. As a result, instructions data 136 may generate advanced instructions or a particular aerobic activity. This may help an instructor understand the participants present within the class. Similarly participant data 132 may include votes from participants for a particular aerobic activity wherein the highest vote is chosen. In some cases, instructor may use instructions data 136 to understand the particular activity that will be instructed for the class. In some cases, instructions data 136 may further be generated as a function of participant data 132 wherein instructions data 136 may be modified based on the capabilities of participants. This may include capabilities present in this classroom (participants can or cannot raise their legs above their hips) or previously determined capabilities received prior to the class (participants have asthma or cannot perform particular activities).

With continued reference to FIG. 1, In some cases, instructions data 136 may include advice data wherein advice data may signify to a participant that they are not properly engaging in the class. Advice data may be generated as a function of participant data 132. In some cases, advice data may be generated as a function of a participant pose data 148. Participant pose data 148 may be similar to instructor pose data wherein participant pose data 148 may include the pose of a participant. Participant pose data 148 may be generated similar to instructor pose data as described above. Participant pose data may further include a pose score, wherein the pose score is an indicator as to how well a participant is achieving a pose. Pose score may be a numerical score or any other score that may indicate the capabilities of the participant. For example, a pose score of 20 may indicate that a user is not following the activity correctly whereas a pose score of 90 may indicate that a participant if following the activity correctly. Participant pose data maybe compared to predetermined participant data wherein the predetermined participant data is predetermined data of an ideal pose of a participant. Participant pose data may be compared to predetermined participant data wherein pose score may be determined based on the comparison. For example, when a participant pose is nearly identical to a pose in predetermined pose data then a numerical score of around 100 may be given. Predetermined participant pose data may be retrieved from a database. In some cases, predetermined participant pose data may be received from previous inputs. In some cases, the image classifier mentioned above may be used to determine participant pose data. Advice data may be generated as a function of participant pose data 148 and instructor pose data wherein participant pose data 148 and instructor pose data are compared and data is generated displaying the degree of match between participant pose data 148 and instructor data 124. The degree of match may then be used to signify to a participant how close or off they are based on the comparison. Advice data may further contain improvement data based on the degree of match wherein improvement data may include improvement on how a user may fix their pose. Improvement data may be retrieved from a database and sorted using a lookup table as described in this disclosure. Similarly, advice data may indicate to an instructor whether certain poses are too difficult to achieve for certain participants. For example, advice data may contain a degree of match wherein a low degree of match may indicate that participants cannot properly achieve specific poses. This may indicate to an instructor that the instructor may not focus on an easier aerobic activity or a less intensive one. The opposite may further be true wherein a high degree of match may indicate that participants are currently capably of achieving the current aerobic activities or poses. This in turn may indicate to an instructor that participants are following along and may be more capable of more intensive activities. Improvement data may be generated wherein improvement data may indicate to an instructor to speed up, slow down, increase or decrease intensity and the like.

With continued reference to FIG. 1, generating the instructions data 136 as a function of the instructor data 124 may further include generating instructions data 136 using a machine learning model. Generating the instructions data 136 as a function of the instructor data 124 may include receiving instruction training data 140. In an embodiment, instruction training data 140 may include a plurality of instructor data 124 that is correlated to a plurality of instructions data 136. For example, instruction training data 140 may be used to show instructor data 124 that is correlated to one the plurality of instructions data 136. In an embodiment instructions data 136 may be used to instruct a participant on the moves, positions or materials used by the instructor. In some embodiments, instructions training data may be received from a user, third party, database, external computing device 112s, previous iterations of processing, and/or the like as described in this disclosure. Instruction training data 140 may further be comprised of previous iterations of instructor data 124 and instructions data 136. Instructions training data may be stored in a database and/or retrieved from a database. Generating instructions data 136 may further include training an instruction machine learning model 144 as a function of instruction training data 140 and generating instructions data 136 as a function of the instruction machine learning model 144. In some cases, instruction training data 140 may be trained through participant input wherein a participant may determine if the instructions data 136 is accurate and/or applicable to the current class instructions.

With continued reference to FIG. 1, in one or more embodiments, processor 116 may implement one or more aspects of “generative artificial intelligence (AI),” a type of AI that uses machine learning algorithms to create, establish, or otherwise generate data such as, without limitation, classroom data, instructor feedback, and/or the like in any data structure described herein (e.g., text, image, video, audio, among others) that is similar to one or more provided sets of training data. In an embodiment, action module described herein may include one or more generative machine learning models that are trained on one or more set of examples. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

Still referring to FIG. 1, in some cases, generative machine learning models may include one or more generative models. As described herein, “generative models” refers to statistical models of the joint probability distribution P(X, Y) on a given observable variable x, representing features or data that can be directly measured or observed (e.g., video clips or images of user's poses and movements, sensor readings from wearable devices and/or plurality of sensors, time-series data representing sequence of poses or transitions, audio recordings of user's breathing patterns or verbal responses, and/or the like) and target variable y, representing the outcomes or labels that one or more generative models aims to predict or generate (e.g., instructor feedback, corrective instructions, guidance, error flags or annotations, supplementary content, and/or the like). In some cases, generative models may rely on Bayes theorem to find joint probability; for instance, and without limitation, Naïve Bayes classifiers may be employed by processor 116 to categorize input data such as, without limitation, yoga poses into different classes such as, without limitation, difficulty levels based on observable features described herein.

In a non-limiting example, and still referring to FIG. 1, one or more generative machine learning models may include one or more Naïve Bayes classifiers generated, by processor 116, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)-P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction.

Still referring to FIG. 1, although Naïve Bayes classifier may be primarily known as a probabilistic classification algorithm; however, it may also be used as a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)=P(Y)ΠiP(Xi|Y), wherein P(Y) may be the prior probability of the class, and P(Xᵢ|Y) is the conditional probability of each feature given the class. One or more generative machine learning models containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine learning models containing Naïve Bayes classifiers may select a class label y according to prior distribution P(Y), and for each feature Xᵢ, sample at least a value according to conditional distribution P(Xᵢ|y). Sampled feature values may then be combined to form one or more new data instance with selected class label y. In a non-limiting example, one or more generative machine learning models may include one or more Naïve Bayes classifiers to generate new examples of yoga poses based on difficulty levels (e.g., beginner, intermediate, advanced), wherein the models may be trained using training data containing a plurality of features e.g., body alignment, balance, pose complexity, and/or the like as input correlated to a plurality of labeled classes e.g., difficulty levels as output.

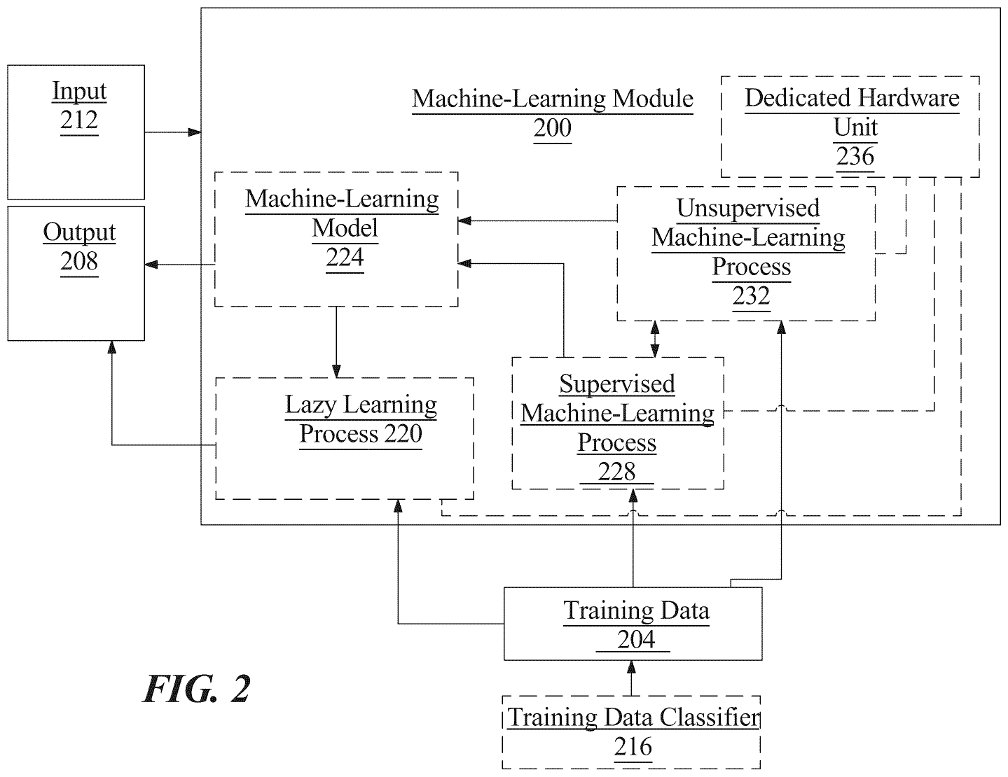

Still referring to FIG. 1, in some cases, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail with reference to FIG. 2.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 2 to distinguish between different categories e.g., real vs. fake, or states e.g., TRUE vs. FALSE within the context of generated data such as, without limitations, yoga poses, yoga instructions, and/or the like. In some cases, processor 116 may implement one or more classification algorithms such as, without limitation, Support Vector Machines (SVM), Logistic Regression, Decision Trees, and/or the like to define decision boundaries.

In a non-limiting example, and still referring to FIG. 1, generator of GAN may be responsible for creating synthetic data that resembles real yoga instruction content. In some cases, GAN may be configured to receive instructor data such as, without limitation, one or more video clips of one or more users, as input and generates corresponding instruction texts or even supplementary videos containing information describing or evaluating the performance of one or more poses shown in each of the received video clips. On the other hand, discriminator of GAN may evaluate the authenticity of the generated content by comparing it to real yoga instruction data, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and still referring to FIG. 1, VAE may be used by processor 116 to model complex relationships between instructor data e.g., different poses, movements, and alignments. In some cases, VAE may encode input data into a latent space, capturing essential characteristics of user's poses and movements. Such encoding process may include learning one or more probabilistic mappings from observed instructor data to a lower-dimensional latent representation. Latent representation may then be decoded back into the original data space, therefore reconstructing the observed user actions. In some cases, such decoding process may allow VAE to generate new examples or variations that are consistent with the learned distributions.

With continued reference to FIG. 1, in some embodiments, one or more generative machine learning models may be trained on a plurality of video clips of users performing various poses and actions as described herein, wherein the plurality of video clips may provide visual information that generative machine learning models analyze to understand the dynamics of yoga movements. In other embodiments, training data may also include voice-over instructions and feedback from instructors. In some cases, such data may help generative machine learning models to learn appropriate language and tone for providing instructions/guidance on various yoga poses and/or movements. Additionally, or alternatively, one or more generative machine learning models may utilize one or more predefined templates representing, for example, and without limitation, correct yoga poses. In a non-limiting example, one or more movement templates (i.e., predefined models or representations of correct and ideal physical movements, poses, or actions associated with specific yoga practices) may serve as benchmarks for comparing and evaluating plurality of video clips containing user's movement.

Still referring to FIG. 1, processor 116 may configure generative machine learning models to analyze input data such as, without limitation, video clips or other instructor data and compare input data to one or more predefined templates such as movement templates representing correct yoga poses described above, thereby allowing processor 116 to identify discrepancies or deviations from the ideal form. In some cases, processor 116 may be configured to pinpoint specific errors in alignment, posture, balance, timing, or any other aspects of the user action. In a non-limiting example, processor 116 may be configured to implement generative machine learning models to incorporate additional models to detect a misaligned spine, an incorrect angle of a joint, or an improper transition between a first pose and a second pose. In some cases, errors may be classified into different categories or severity levels. In a non-limiting example, some errors may be considered minor, and generative machine learning model such as, without limitation, GAN may be configured to generate instructions contain only slight adjustments while others may be more significant and demand more substantial corrections. In some embodiments, processor 116 may be configured to flag or highlight poses that are performed incorrectly, altering the instructor or user to areas that need attention, directly on the video clip using one or more generative machine learning models described herein. In some cases, one or more generative machine learning models may be configured to generate and output indicators such as, without limitation, visual indicator, audio indicator, and/or any other indicators as described above. Such indicators may be used to signal the detected error described herein.

With continued reference to FIG. 1, in a non-limiting example, processor 116 may be configured to handle a group setting, for example, and without limitation, a yoga class may include a plurality of participants (i.e., users). In such embodiment, processor 116 may be configured to detect, using computer vision model described above, commonalities of deficiencies (i.e., errors) in movements among plurality of users, as compared to predefined “ideal” movements or poses (i.e., movement template). Computer vision model and/or one or more machine learning models described herein may be configured to perform pose detection, and analyze alignment, balance, and other key aspects of each detected pose. In some cases, one or more skeletal representations, each corresponding to each individual user of plurality of users, may be formed using computer vision model by connecting a plurality of points based on anatomical structure identified based on visual data such as, without limitation, a video clip of a group session. Computer vision model may use pairwise relations and graph algorithms to determine connections based on known relationships between joints e.g., knee connected to hip to construct a coherent skeleton. In some cases, processor 116 may be configured to identify and rank detected common deficiencies across plurality of users; for instance, and without limitation, one or more machine learning models may classify errors in a specific order e.g., a descending order of commonality. Such ranking process may enable a prioritization of most prevalent issues, allowing instructors or processor 116 to address the widespread challenges first. In a non-limiting example, if 80% of participants are struggling with a specific alignment in a particular pose, that issue may be detected and targeted with corrective instructions or demonstrations generated by one or more generative machine learning models.

Still referring to FIG. 1, in some cases, one or more generative machine learning models may also be applied by processor 116 to edit, modify, or otherwise manipulate existing data or data structures. In an embodiment, output of training data used to train one or more generative machine learning models such as GAN as described herein may include textual instructions or supplementary videos that linguistically or visually demonstrate modified instructor data e.g., guidance to adjust specific body parts, corrected alignment or execution of the pose, and/or the like. In some cases, supplementary videos may be synchronized with the user's performance, for example, and without limitation, in a side-by-side or even overlayed arrangement with the input instructor data, providing real-time visual guidance. Additionally, or alternatively, voice-over guidance may be generated using generative machine learning models to verbally guide users through the corrections. In some cases, such auditory feedback may be integrated with the supplementary videos, offering user a multisensory instructional experience.

Additionally, or alternatively, and still referring to FIG. 1, processor 116 may be configured to continuously monitor instructor data. In an embodiment, processor 116 may configure discriminator to provide ongoing feedback and further corrections as needed to subsequent input data (e.g., video clips or other data related to user's movements and poses during a yoga session). In some cases, one or more sensors such as, without limitation, wearable device, motion sensor, or other sensors or devices described herein may provide additional instructor data that may be used as subsequent input data or training data for one or more generative machine learning models described herein. An iterative feedback loop may be created as processor 116 continuously receive real-time data, identify errors as a function of real-time data, delivering corrections based on the identified errors, and monitoring user responses on the delivered corrections. In an embodiment, processor 116 may be configured to retrain one or more generative machine learning models based on user responses or update training data of one or more generative machine learning models by integrating user response into the original training data. In such embodiment, iterative feedback loop may allow machine learning module to adapt to the user's needs and performance, enabling one or more generative machine learning models described herein to learn and update based on user responses and generated feedback.

With continued reference to FIG. 1, other exemplary embodiments of generative machine learning models may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine learning models may be used to generate and/or modify instructor data, class data, instructor feedback, and/or any other data described herein.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by processor 116 to generate real-time instructor feedback in yoga class setting. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various generative machine learning models may be used to generate and/or modify instructor data, class data, instructor feedback, and/or any other data described herein. As an ordinary person skilled in the art, upon reviewing the entirety of this disclosure, will be aware of various multi-model neural network and combination thereof that may be implemented by apparatus 100 in consistent with this disclosure.

With continued reference to FIG. 1, generating instructions data 136 may include matching instructions data 136 to class content. For example, and without limitation, a computing device may be configured to link certain image and/or video clips to certain class content such as a pose and/or instructions to the pose.

Still referring to FIG. 1, in some embodiments, generating instructions data 136 may include fragmenting instructions. For example, a computing device may be configured to break a recorded session into modular sections that can be categorized (such as via a classifier) and/or rearranged for further processing steps described in this disclosure. In some embodiments, instructions data may be fragmented based on a change in categorization a machine learning model. In some embodiments, instructions data may be fragmented based on class participant (such as instructor) input.

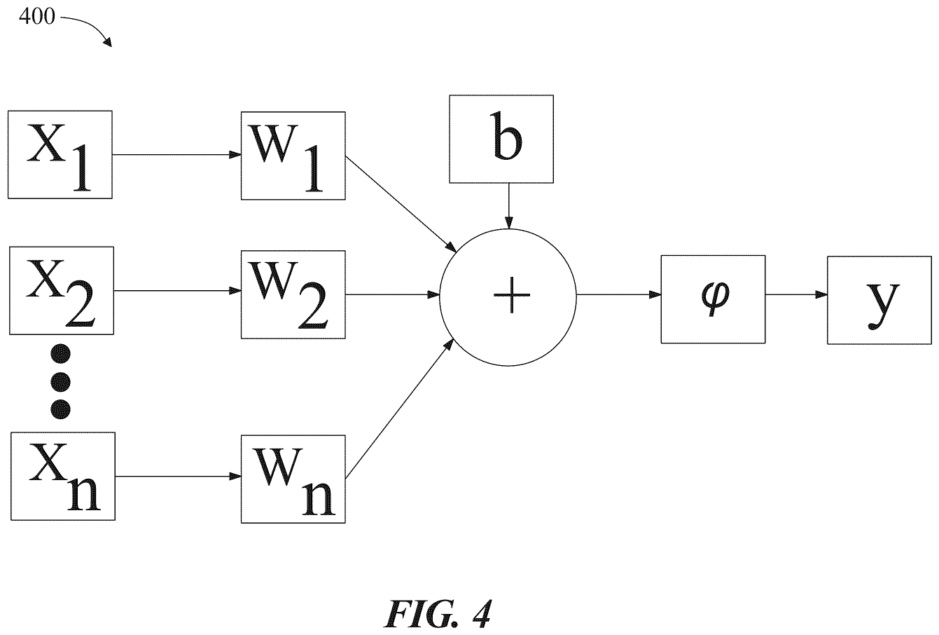

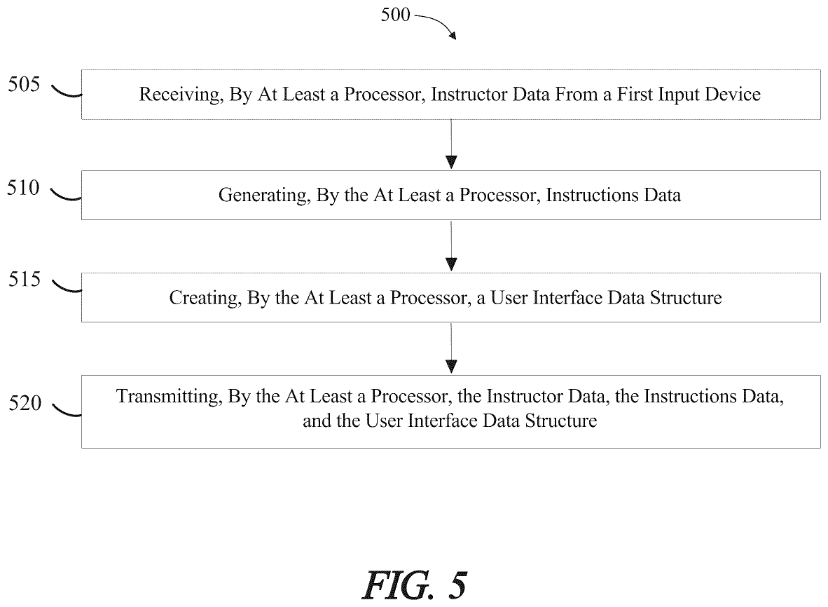

Continuing with reference to FIG. 1, in a further non-limiting embodiment, generating instructions data may include overlay instruction data, for example, desired form for a user on a video feed such as video clip of user's or instructor's body. In some cases, desired form may be included in one or more supplementary videos generated based on class action data using one or more generative machine learning models described above. In a non-limiting example, such overlay may include a stick figure, avatar, dummy image, or other visual representation that illustrates the proper alignment or posture for a particular yoga pose or movement. In some cases, overlay may also be scaled and adapted to specific user; for instance, and without limitation, processor 116 may take into account data describing one or more attributes of individual user e.g., height, body proportions, gender, or any other relevant factors. In an embodiment, scaling of the overlay may be achieved through one or more computer vision techniques, anthropometric modeling, and/or machine learning algorithms. In a non-limiting example, processor 116 may be configured to generate a customized overlay that aligns with user's unique physique using a deep neural network as described in further detail below with reference to FIGS. 4-5, trained using training data containing a plurality of body measurements, postures, and/or alignments as input correlated to a plurality of desired pose representations as output. In another non-limiting example, processor 116 may utilize skeletal tracking and geometric transformation algorithms to adapt the overlay to the user's specific body proportions and movements. In some cases, processor 116 may be configured to identify a plurality of key anatomical landmarks such as, without limitations, joints, spine alignment, and/or the like, and map the plurality of key anatomical landmarks to a standardized model such as, without limitation, a stick figure or avatar. Mapped model may then be scaled and transformed to match user's actual dimensions and pose, ensuring that the overlay provides an accurate and intuitive visual guide. Additionally, or alternatively, gender-specific adjustments, biomechanical constraints, and other individualized factors may be incorporated into the scaling process, further enhancing the overlay's relevance and effectiveness Further, overlay may be registered to view feed using field coordinate system as described above to ensure the generated visual representation maintains its spatial relationships with users' body as they move. In some cases, overlay may be animated or dynamically adjusted to guide user through a sequence of poses and provide real-time feedback and correction, In a non-limiting example, if a user's alignment deviates from the movement template, the overlay may change color, flash, vibrate or provide other visual cues to signal the error.

Still referring to FIG. 1, a computing device 112 may be configured to determine an instructions data modifier based on an analysis of instructions data 136. A instructions data modifier may be determined using an action module. For example, a computing device may be communicatively connected to a video capture device, and a computing device may include at least a processor and a memory communicatively connected to the at least processor, the memory containing instructions configuring the at least processor to determine a instructions data modifier based on an analysis of instructions data 136.

Still referring to FIG. 1, as used herein, an “instructions data modifier” is an element of data related to a change in instructions data 136. A instructions data modifier may indicate that a modification in fitness class content is needed. For example, a instructions data modifier may indicate that additional guidance as to how to perform a pose is necessary. As another example, a instructions data modifier may indicate that a pre-planned video or audio segment should be replaced by an alternate element of fitness class content, such as an element of fitness class content that provides additional guidance as to how to perform a pose. As another example, a instructions data modifier may indicate that an element of fitness class content, such as one that provides additional guidance, should be inserted between pre-planned video or audio segments. As another example, a instructions data modifier may indicate that a historical tutorial video should be displayed in a picture in picture format.

Still referring to FIG. 1, a instructions data modifier may be determined based on categorization of instructions data 136, such as categorization by a machine learning model. For example, if a machine learning model categorizes instructions data 136 as data associated with an instruction to perform a pose, then a instructions data modifier for displaying an instructional video on performing that pose may be determined.

Still referring to FIG. 1, as another example, and without limitation, an instructions data modifier may include language guidance, such as a warning to an instructor that their description is too complicated. Language guidance may use the output of a language model described above. In an embodiment, instructions data 136 is input into a language model and the language model outputs an interpretation of speech included in the instructions data 136 (for example, a language model may output a text transcript of an instructor's speech). Such an output may be used to determine the statistical prevalence of a word or phrase used by a class participant, such as an instructor. Low statistical prevalence may be associated with difficult to understand instruction. For example, if an instructor uses a low statistical prevalence word, then the instructor may be notified that the word is complex and may not be understood. In some embodiments, an apparatus identifies a higher statistical prevalence word or phrase to use to substitute a low statistical prevalence word or phrase. In a non-limiting example, if an instructor uses a low statistical prevalence word or phrase, an apparatus may identify a higher statistical prevalence word or phrase that has the same meaning or a similar meaning and may display to the instructor a suggestion to use the higher statistical prevalence word or phrase. In some embodiments, an apparatus identifies a lower statistical prevalence word or phrase to use to substitute a high statistical prevalence word or phrase, such as if higher variety is desired. In a non-limiting example, if an instructor uses a high statistical prevalence word or phrase, an apparatus may identify a lower statistical prevalence word or phrase that has the same meaning or a similar meaning and may display to the instructor a suggestion to use the lower statistical prevalence word or phrase. In some embodiments, an apparatus may identify an alternative word or phrase, such as a higher or lower prevalence word or phrase and may determine a instructions data modifier as a function of the alternative word or phrase.

With continued reference to FIG. 1, memory 120 further contains instructions to create a user interface data structure 152. As used in this disclosure, “user interface data structure” is a data structure representing a specialized formatting of data on a computer so that the information can be organized, processed, stored, and retrieved quickly and effectively for a user interface. Users interface structure includes instructor data 124 and instructions data 136. In some cases, user interface data structure 152 includes second view data 128 as described above. In some cases, user interface data structure 152 further includes participant input and/or participant data 132 as described above. Additionally, or alternatively, processor 116 may be configured to generate user interface data structure 152 using any combination of data as described in this disclosure.

With continued reference to FIG. 1, memory 120 further contains instructions to transmit the instructor data 124, the instructions data 136, and the user interface data structure 152. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. Memory 120 may transmit the data described above to a database wherein the data may be accessed from a database, memory 120 may further transmit the data above to a device display or another computing device 112.

With continued reference to FIG. 1, apparatus 100 further includes a graphical user interface 156 (GUI 156) communicatively connected to at least a processor 116. For the purposes of this disclosure, a “user interface” is a means by which a user and a computer system interact; for example through the use of input devices and software. A user interface may include graphical user interface 156, command line interface (CLI), menu-driven user interface, touch user interface, voice user interface (VUI), form-based user interface, any combination thereof and the like. In some embodiments, a user may interact with the user interface using a computing device 112 distinct from and communicatively connected to at least a processor 116. For example, a smart phone, smart, tablet, or laptop operated by the user and/or participant. A user interface may include one or more graphical locator and/or cursor facilities allowing a user to interact with graphical models and/or combinations thereof, for instance using a touchscreen, touchpad, mouse, keyboard, and/or other manual data entry device. A “graphical user interface,” as used herein, is a graphical form of user interface that allows users to interact with electronic devices. In some embodiments, GUI 156 may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface 156. skilled in the art, upon reviewing the entirety of this disclosure, will be aware of various ways in which a graphical user interface 156 and/or elements thereof may be implemented and/or used as described in this disclosure.

With continued reference to FIG. 1, GUI 156 is configured to receive the user interface structure and display instructions data 136 and instructor data 124 as a function of the user interface data structure 152. GUI 156 may be displayed on a display device. Display device may include, but is not limited to, a smartphone, tablet, laptop, monitor, tablet, and the like. Display device may include a separate device that includes a transparent screen configured to display computer generated images and/or information. In some cases, GUI 156 may be displayed on a plurality of display devices. Additionally, or alternatively instructor data 124 may be displayed on a first display device and instructions data 136 on a second display device. Additionally, or alternatively previous class data may be displayed on a first display device wherein current class data may be displayed on a second device display. Current class data and previous class may be displayed simultaneously or in sequence. In some cases, display device may contain multiple viewing screens wherein instructor data 124, instructions data 136, and any other data described in this disclosure are displayed on separate viewing screens. Additionally, or alternatively, the data may be shown simultaneously or in sequence. The user may view the information displayed on the display device in real time. GUI 156 may be further configured to receive participant input as described above. In some cases, GUI 156 may contain an interaction feature 160 wherein an interaction feature 160 is configured to allow a user/participant to interact with GUI 156. Interaction feature 160 may include a button or similar clickable elements wherein the clicking of the button may initiate a response or a command. Interaction feature 160 may further contain drop down menus where a user may choose from a list of commands wherein the list of commands may perform different functions. For example, a command may include pausing or stopping the audio-visual data that is being displayed. In another example a command may include rewinding a video that is being displayed through graphical user interface 156. Interaction feature 160 may further include dialog or comment boxes wherein users may enter comments about a specific activity. Comment boxes may be consistent with participant input as described above when a user may input data and/or comment into a comment box. Interaction feature 160 may further contain functions to allow a user to zoom in or out in a video device. Interaction feature 160 may further allow a user to modify or change instructions data 136 as described above. For example, a user may choose a set of instructions from a plurality of instructions wherein each set of instructions may contain a differing difficulty level of a particular activity. In another non-limiting example, user may choose a set of instructions that are applicable to a specific class. Interaction feature 160 may further allow users to move around objects located on a display device. For example, a user may situate two sets of audio-visual data on a screen wherein one set of audio-visual data is displayed on a right side of the screen, and another is displayed on a left side of the screen. Continuing the example, a user may choose to display current class data on a left side of a screen on display device and display previous class data on a right side of a screen on display device. Interaction feature 160 may further allow a user to access previous class data wherein previous class data may comprise a plurality of previously recorded audio-visual data. User may select a one of the plurality of previously recorded audio-visual data to be displayed.

Still referring to FIG. 1, systems and methods for fitness class generation may include a system or method disclosed in U.S. patent application Ser. No. 18/368,867, filed on Sep. 15, 2023, and titled “SYSTEMS AND METHODS FOR FITNESS CLASS GENERATION,” and attorney docket number 1179-002USU1 the entirety of which is hereby incorporated by reference. Classes may be administered, without limitation, using classroom configurations and/or components as described in U.S. patent application Ser. No. 18/369,023, filed on Sep. 15, 2023, and titled “FITNESS CLASSROOM ASSEMBLY AND A METHOD OF USE,” the entirety of which is hereby incorporated by reference. Classes may be scheduled, without limitation, as disclosed in U.S. patent application Ser. No. 18/368,915, filed on Sep. 15, 2023, and titled “APPARATUS FOR CLASSROOM SCHEDULING AND METHOD OF USE,” the entirety of which is incorporated herein by reference.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include class action data as described above as inputs, class action data modifier as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

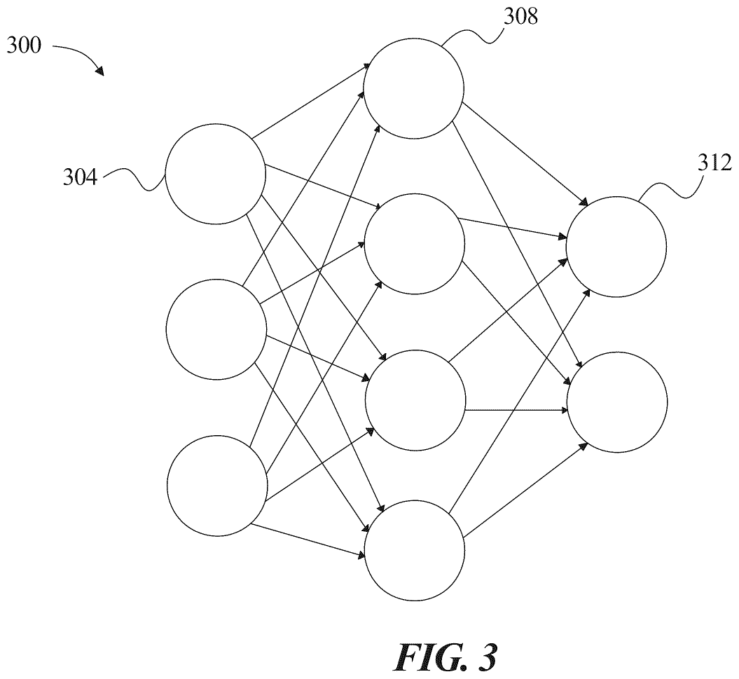

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

With continued reference to FIG. 3, in an embodiment, neural network may include a deep neural network (DNN). As used in this disclosure, a “deep neural network” is defined as a neural network with two or more hidden layers. In a non-limiting example, neural network may include a convolutional neural network (CNN). Generating instruction data, or any other data described above may include training CNN using training data such as any training data described above with reference to FIGS. 1-2, and generating class data and/or instructor data/feedback using trained CNN. A “convolutional neural network,” for the purpose of this disclosure, is a neural network in which at least one hidden layer is a convolutional layer that convolves inputs to that layer with a subset of inputs known as a “kernel,” along with one or more additional layers such as pooling layers, fully connected layers, and the like. In some cases, CNN may include, without limitation, a deep neural network (DNN) extension. Mathematical (or convolution) operations performed in the convolutional layer may include convolution of two or more functions, where the kernel may be applied to input data e.g., frames of given video clips through a sliding window approach. In some cases, convolution operations may enable processor 116 to detect local/global patterns, edges, textures, and any other features described herein within each frames. Features may be passed through one or more activation functions, such as without limitation, Rectified Linear Unit (ReLU), to introduce non-linearities into the data generation process. Additionally, or alternatively, CNN may also include one or more pooling layers, wherein each pooling layer is configured to reduce the dimensionality of input data while preserving essential features within the input data. In a non-limiting example, CNN may include one or more pooling layer configured to reduce the dimensions of feature maps by applying downsampling, such as max-pooling or average pooling, to small, non-overlapping regions of one or more features.

Still referring to FIG. 3, CNN may further include one or more fully connected layers configured to combine features extracted by the convolutional and pooling layers as described above. In some cases, one or more fully connected layers may allow for higher-level pattern recognition. In a non-limiting example, one or more fully connected layers may connect every neuron (i.e., node) in its input to every neuron in its output, functioning as a traditional feedforward neural network layer. In some cases, one or more fully connected layers may be used at the end of CNN to perform high-level reasoning and produce the final output such as, without limitation, class data such as yoga poses examples. Further, each fully connected layer may be followed by one or more dropout layers configured to prevent overfitting, and one or more normalization layers to stabilize the learning process described herein.

With continued reference to FIG. 3, in an embodiment, training the neural network such as CNN may include selecting a suitable loss function to guide the training process. In a non-limiting example, a loss function, measures the difference between the generated instruction data and the ground truth instruction data in the training data, may be used, such as, without limitation, mean squared error (MSE) or a custom loss function may be designed for one or more embodiments described herein. Additionally, or alternatively, optimization algorithms, such as stochastic gradient descent (SGD), may then be used to adjust the CNN's parameters to minimize such loss. In a further non-limiting embodiment, instead of directly generating instruction data, Neural network may be trained as a regression model to predict one or more numeric values within instruction data. Additionally, CNN may be extended with additional deep learning techniques, such as recurrent neural networks (RNNs) or attention mechanism, to capture additional features and/or data relationships within input data. These extensions may further enhance the accuracy and robustness of the generation of instruction data described herein.

Referring now to FIG. 4, an exemplary embodiment of a node 4400 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a(1+tanh (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function p, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring now to FIG. 4, an exemplary embodiment of a node of a neural network is illustrated. A node may include, without limitation, a plurality of inputs xi that may receive numerical values from inputs to a neural network containing the node and/or from other nodes. Node may perform a weighted sum of inputs using weights wᵢ that are multiplied by respective inputs xi. Additionally or alternatively, a bias b may be added to the weighted sum of the inputs such that an offset is added to each unit in the neural network layer that is independent of the input to the layer. The weighted sum may then be input into a function p, which may generate one or more outputs y. Weight wᵢ applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight.

Referring now to FIG. 5, a method 500 of administering a classroom is illustrated. At step 505, method 500 includes receiving by at least a processor, instructor data from a first input device, wherein the first input device is configured to receive at least audio-visual data of an instructor. In some cases, the instructor data further includes previous class data and current class data. In some cases, the method further includes receiving, by the at least a processor, second view data from a second input device. In some cases, the method further includes receiving, by the at least a processor, participant data from a second input device. This step may be implemented as described above with reference to FIGS. 1-5, without limitation.

With continued reference to FIG. 5, at step 510 method 500 includes generating, by the at least a processor, instructions data. In some cases, generating the instructions data comprises generating the instructions data as a function of the instructor data. in some cases, generating, by the at least a processor, the instructions data as a function of the instructor data comprises receiving instruction training data comprising a plurality of instructor data correlated to a plurality of the instructions data, training an instruction machine learning model as a function of the instruction training data, and generating the instructions data as a function of the instruction machine learning model. In some cases, generating, by the at least a processor, the plurality of instructor data as a function of the instructor data includes determining instructor pose data as a function of the instructor data and generating the plurality of instructions data as a function of the instructor pose data. In some cases, generating, by the at least a processor, the instructions data further includes generating, by the at least a processor the instructions data as a function of user input. This step may be implemented as described above with reference to FIGS. 1-5, without limitation.

With continued reference to FIG. 5, at step 515 method 500 includes creating by the at least a processor, a user interface data structure, wherein the user interface data structure comprises the instructor data and the instructions data. This step may be implemented as described above with reference to FIGS. 1-5, without limitation.

With continued reference to FIG. 5, at step 520, method 500 includes transmitting, by the at least a processor, the instructor data, the instructions data, and the user interface data structure to a graphical user interface (GUI) communicatively connected to the at least a processor. The GUI is configured to receive the user interface data structure and display the instructions data and the instructor data as a function of the user interface data structure. In some cases, the GUI further includes an interaction feature, the interaction feature configured to allow a user to interact with the GUI. In some cases, the method further includes displaying, by the at least a processor, the previous class data on a first device display and displaying, by the at least a processor, the current class data on a second device display

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

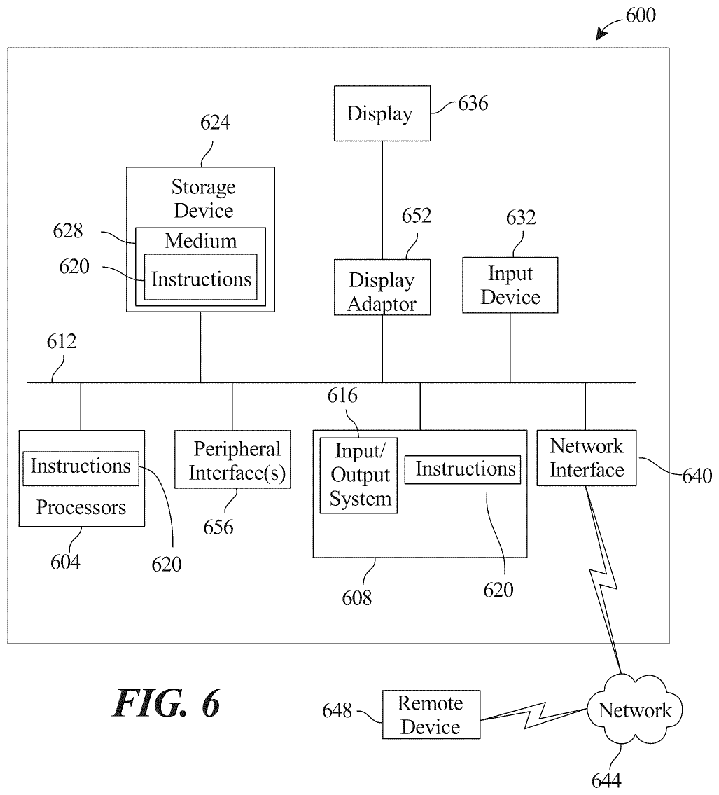

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, apparatuses and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for class administration, the apparatus comprising:
a first input device, the first input device configured to receive at least audio-visual data of an instructor;
at least a processor;
a memory communicatively connected to the at least a processor, wherein the memory contains instructions configuring the at least a processor to:
receive instructor data from the first input device;
generate instructions data;
create a user interface data structure, wherein the user interface data structure comprises the instructor data and the instructions data; and
transmit the instructor data, the instructions data, and the user interface data structure; and
a graphical user interface (GUI) communicatively connected to the at least a processor, the GUI configured to:
receive the user interface data structure; and
display the instructions data and the instructor data as a function of the user interface data structure.

2. The apparatus of claim 1, the instructor data further comprising previous class data and current class data.

3. The apparatus of claim 1, the apparatus further comprising a second input device, the second input device configured to receive second view data.

4. The apparatus of claim 1, the apparatus further comprising a second input device, the second input device configured to receive participant data.

5. The apparatus of claim 1, wherein generating the instructions data comprises generating the instructions data as a function of the instructor data.

6. The apparatus of claim 5, wherein generating the instructions data as a function of the instructor data comprises:
receiving instruction training data comprising a plurality of instructor data correlated to a plurality of the instructions data;
training an instruction machine learning model as a function of the instruction training data; and
generating the instructions data as a function of the instruction machine learning model.

7. The apparatus of claim 5, wherein generating the plurality of instructor data as a function of the instructor data comprises:
determining instructor pose data as a function of the instructor data; and
generating the instructions data as a function of the instructor pose data.

8. The apparatus of claim 1, wherein the GUI further comprises an interaction feature, the interaction feature configured to allow a user to interact with the GUI.

9. The apparatus of claim 2, wherein the previous class data is displayed on a first device display and the current class data is displayed on a second device display.

10. The apparatus of claim 1, wherein the instructions data is generated as a function of a participant input.

11. A method of administering a class, the method comprising:
receiving by at least a processor, instructor data from a first input device, wherein the first input device is configured to receive at least audio-visual data of an instructor.
generating, by the at least a processor, instructions data;
creating by the at least a processor, a user interface data structure, wherein the user interface data structure comprises the instructor data and the instructions data; and
transmitting, by the at least a processor, the instructor data, the instructions data, and the user interface data structure to a graphical user interface (GUI) communicatively connected to the at least a processor, wherein the GUI is configured to:
receive the user interface data structure; and
display the instructions data and the instructor data as a function of the user interface data structure.

12. The method of claim 11, wherein the instructor data further comprising previous class data and current class data.

13. The method of claim 11, wherein the method further comprises receiving, by the at least a processor, second view data from a second input device.

14. The method of claim 11, the method comprising receiving, by the at least a processor, participant data from a second input device.

15. The method of claim 11, wherein generating, by the at least a processor, the instructions data comprises generating the instructions data as a function of the instructor data.

16. The method of claim 15, wherein generating, by the at least a processor, the instructions data as a function of the instructor data comprises:
receiving instruction training data comprising a plurality of instructor data correlated to a plurality of the instructions data;
training an instruction machine learning model as a function of the instruction training data; and
generating the instructions data as a function of the instruction machine learning model.

17. The method of claim 15, wherein generating, by the at least a processor, the plurality of instructor data as a function of the instructor data comprises:
determining instructor pose data as a function of the instructor data; and
generating the instructions data as a function of the instructor pose data.

18. The method of claim 1, wherein the GUI further comprises an interaction feature, the interaction feature configured to allow a user to interact with the GUI.

19. The method of claim 12, wherein the method further comprises displaying, by the at least a processor, the previous class data on a first device display and displaying, by the at least a processor, the current class data on a second device display.

20. The method of claim 11, generating, by the at least a processor, the instructions data further comprises generating, by the at least a processor the instructions data as a function of user input.
